(19) United States
(12) Patent Application Publication
(10) Pub. No.: US 2012/0063839 A1
(43) Pub. Date: Mar. 15, 2012

(54) FOLDABLE TRAMPOLINE CONNECTOR

(76) Inventor: Zhi-Ping MO, Zhejiang (CN)

(21) Appl. No.: 12/881,331

(22) Filed: Sep. 14, 2010

(51) Int. Cl. F16B 7/18

(52) U.S. Cl. 403/84; 403/161

(57) ABSTRACT

A foldable trampoline connector includes two connecting pieces hinged to each other. A working surface of a connecting piece is at an inclination complementary to that of another connecting piece. Each connecting piece has a through hole disposed vertically to and on a same axis of its working surface. Both through holes are pivoted to each other with a fastening bolt. The connector solves the problem of chamfering collision by two folding points of both connectors at both extremes of the folding line since a turning axis of both connectors and that of a mobile frame tube are not on the same straight line when a circular jumping bed of the prior art is folded on a semicircular folding line.

### BACKGROUND OF THE INVENTION

(a) Field of the Invention The present invention is related to a connector, and more particularly to a connector for a foldable trampoline frame.

(b) Description of the Prior Art

Though a trampoline is a very popular gymnastic and recreational device, it may create problem of consuming to much space for storage when not used. Therefore, diversified foldable trampolines are generally available in the market. Usually, a trampoline comprises of a circular jumping bed and is folded by a folding line defined by two semicircles. However, upon folding a bigger circular trampoline, having the folding line makes the folding requiring too much efforts and causing difficult handling and storage. To solve the problem, a method of folding the trampoline at a folding line shorter than a semicircle is attempted, but the existing connector with a vertical working surface is proved not applicable for the shorter folding lines since it always exists the problem of chamfering collision by two folding points from both connectors at two extremes of the folding line; that is, a turning axis is not on the same straight line with that of a mobile frame to frustrate the folding in meeting its expected results. Of course, a user may choose to disassemble the trampoline instead of folding it for storage; however, the user has to go through the tiresome process to reassemble the trampoline when the use is desired.

### SUMMARY OF THE INVENTION

The primary purpose of the present invention is to provide a foldable trampoline connector that allows smooth folding of the trampoline using a folding line shorter than a semicircle.

To achieve the purpose, a connector of the present invention is comprised of two connecting pieces I and II hinged to each other; the connecting piece I has a working surface that is of an inclination complementary to that of the connecting piece II; and a through hole is disposed on each connecting piece I, II vertically to its working surface and both through holes are disposed on the same axis and pivoted to each other by means of a fastening bolt.

Accordingly, a turning axis, i.e., the fastening bolt, of both connectors respectively disposed at two extremes of the folding line is at the same straight line with that of a mobile frame tube to facilitate folding the trampoline since the mobile frame tube is able to engage free rotation surrounding the fastening bolt on the connector, thus to solve the problem of chamfering collision by two folding points found with the prior art.

A space to allow rotation of the frame tube is reserved between a top and a bottom of the working surface of the connecting piece I; and a similar space is also reserved in the connecting piece II to further ensure of the free rotation of the mobile frame tube of the circular trampoline in the folding process.

The connecting piece I is disposed with a through hole and the connecting piece II is disposed with two counterbores; and a locating member inserted into the through hole with its head to rest in either counterbore. The locating member helps keep the connector in firm and steady status to guarantee safe use of the connector to the trampoline.

A connecting pin is provided between both through holes respectively from the connecting piece I and the connecting piece II and is forthwith inserted into a counterbore in the through hole of the connecting piece I and a counterbore in the through hole of the connecting piece II to resist comparatively higher sheath and increase the connection strength between both connecting pieces I and II.

A chamfer is provided at the bottom of each working surface.

The through hole of the connecting piece II is internally threaded.

The connector for a foldable trampoline of the present invention not only allows simple construction, easy assembly, and lower production cost but also facilitates folding of a circular trampoline by solving the problem of chamfering collision of the prior art since a turning axis of both connectors disposed at both extremes of a folding line and that of a mobile frame tube are not on the same straight line when a circular trampoline is folded on a non-semicircular folding line.

### BRIEF DESCRIPTION OF THE DRAWINGS

FIG. 1 is a schematic view showing the present invention is mounted to a trampoline.

FIG. 2 is a schematic view showing the trampoline illustrated in FIG. 1 is folded up.

FIG. 3 is a magnified view showing a connector taken from FIGS. 1 and 2.

FIG. 4 is a layout showing a connecting piece I1 taken form FIG. 3.

FIG. 5 is a layout showing a connecting piece II2 taken from FIG. 3.

FIG. 6 is a layout showing a locating member taken from FIG. 3.

FIG. 7 is a bird's view of the locating member taken from FIG. 6.

FIG. 8 is a schematic view showing a construction when both connecting pieces are laterally laid.

FIG. 9 is a schematic view showing a construction when both connecting pieces are laid vertically to each other.

### DETAILED DESCRIPTION OF THE PREFERRED EMBODIMENTS

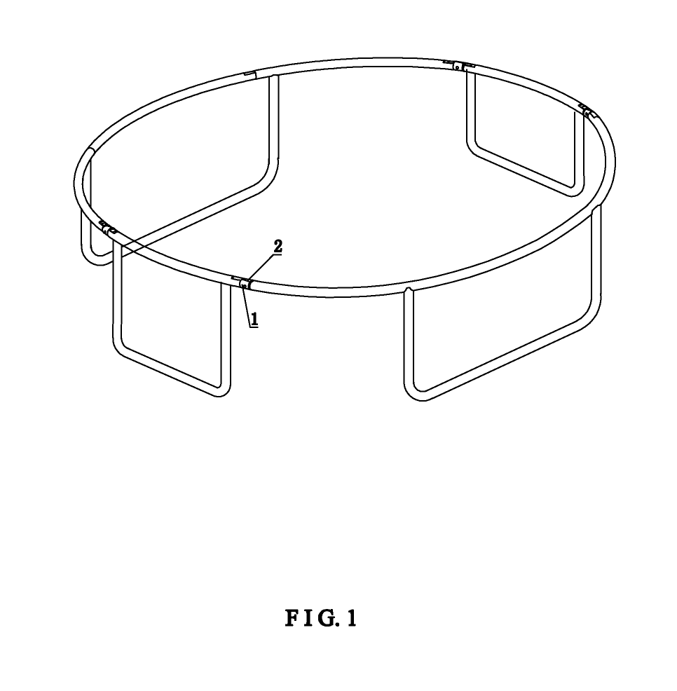

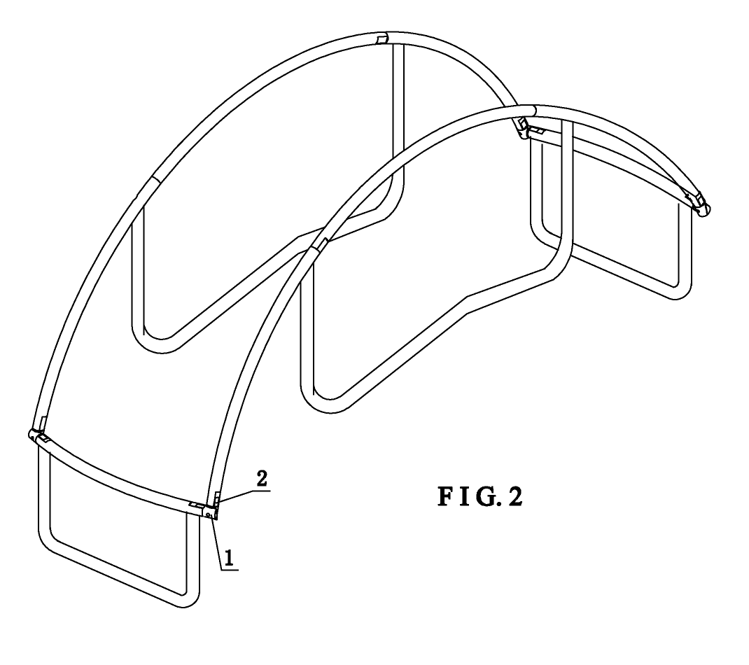

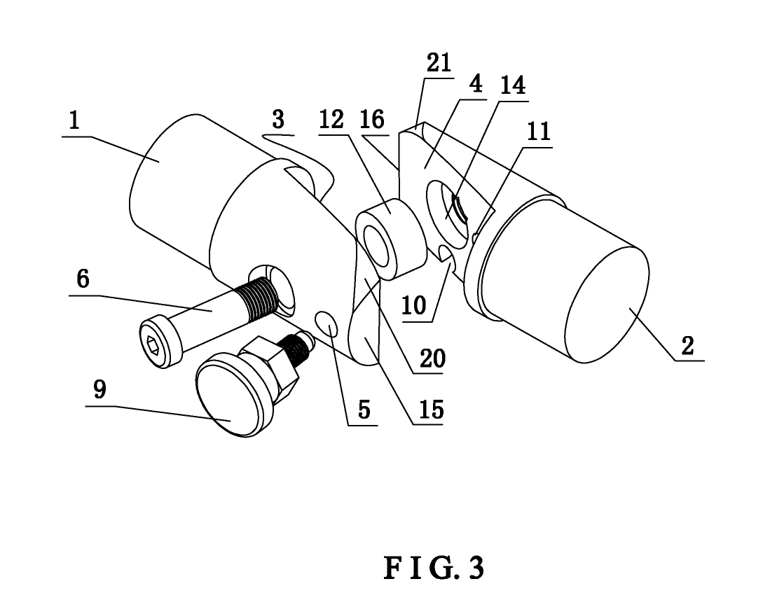

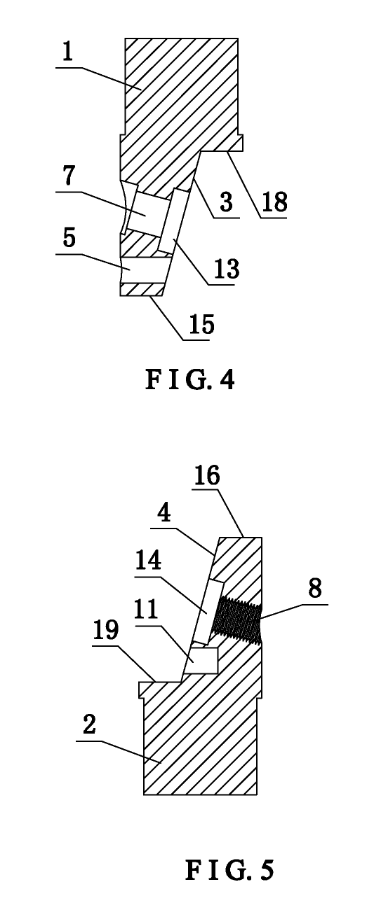

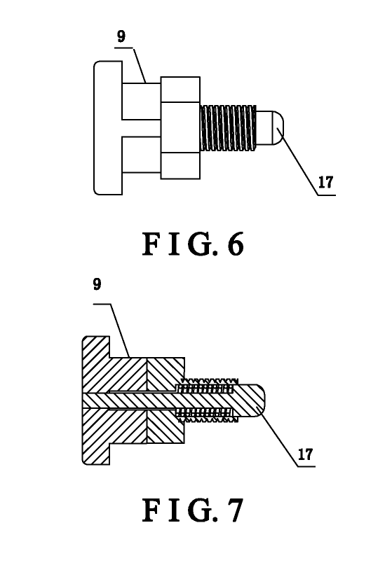

Referring to FIGS. 1 and 2, four arc frame tubes are connected into a circular frame with multiple connectors for a foldable trampoline of the present invention. As illustrated in FIGS. 3, 4, 5, 6, 7, 8, and 9, a connector for a foldable trampoline of the present invention is comprised of a connecting piece I1 and another connecting piece II2 hinged to each other. A work surface 3 of the connecting piece I1 and a working surface 4 of the connecting piece II2 are each provided at an inclination complementary to each other. The connecting piece I1 is connected to a fixed frame tube and the connecting piece II2 is connected to a mobile frame tube. Two through holes 7, 8 are respectively disposed at a right angle to and on the same axis of both working surfaces 3, 4 from the connecting piece I1 and the connecting piece II2, and both through holes 7, 8 are pivoted to each other by means of a fastening bolt 6. The through hole 8 is internally threaded. Another through hole 5 internally threaded 5 is further disposed to the connecting piece I1. Two counterbores 10, 11 are disposed on the connecting piece II2. A locating member 9 passes the through hole 5 with a head 17 of the locating member 5 to rest in either of both counterbores 10 11. A connecting pin 12 is disposed between both through holes 7, 8 to be inserted into a counterbore 13 in the through hole 7 and a counterbore 14 in the through hole 8. Two chamfers 20, 21 are respectively disposed on a bottom 15 of the working surface 3 and a bottom of the working surface 4. Alternatively, two chamfers may be respectively disposed on a top 18 of the working surface 3 and on a top 19 of the working surface 4.

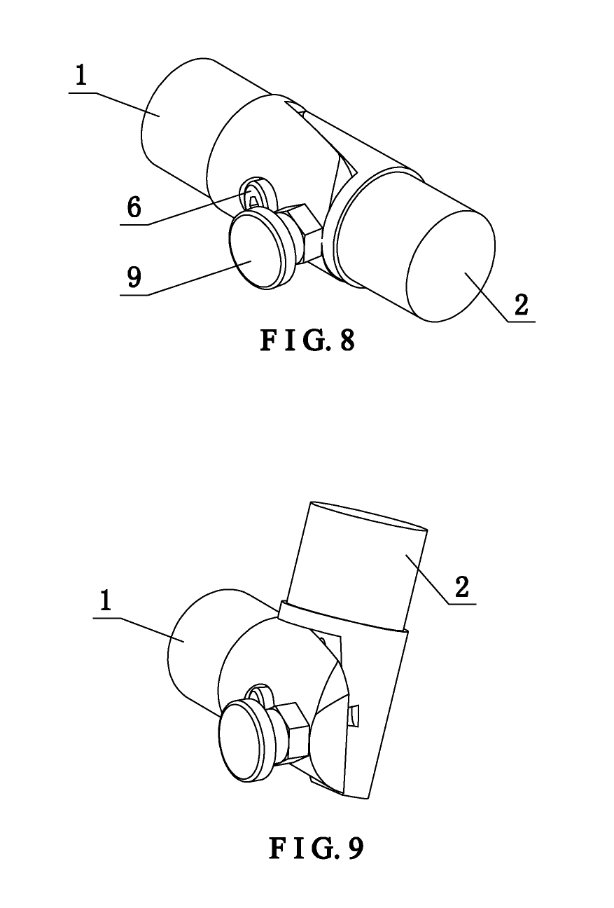

Accordingly, when a jumping bed of the trampoline is stretched, both connecting pieces I1, II2 of the connector are laterally laid in straight as illustrated in FIG. 8 to activate the positioning function of the locating member 9; and the head 17 of the locating member 9 in turn is inserted into the counterbore 11 for the connector to maintain its level in firm and steady status in preventing the jumping bed from being automatically folded due to pull forces from multiple springs connected to the frame tube.

To fold the trampoline, the locating member 9 is first released to retreat the head 17 of the locating member 9 out of the counterbore 11; the mobile fame tube is folded into a vertical status as illustrated in FIG. 9; and the locating member 9 is activated once again to provide its positioning function for the head 17 of the locating member to be inserted into the counter hole 10. Finally, a folding plane is retained to prevent accidental falling frame tube to cause personal injury in the course of handling of the folded trampoline.

I claim:

1. A connector for a foldable trampoline comprising of a first connecting piece and a second connecting piece with both connecting pieces hinged to each other; each connecting piece being disposed with a working surface at an inclination; both inclinations being complementary to each other; each working surface being vertically disposed with a through hole; both through holes being provided on the same axis; and both through holes being pivoted to each other with a fastening bolt.

2. The connector for a foldable trampoline as claimed in claim 1, wherein a chamfering space is reserved between a top and a bottom of the working surface of the first connecting pieces; and a chamfering space is reserved between a top and a bottom of the working space of the second connecting piece.

3. The connector for a foldable trampoline as claimed in claim 1, wherein a through hole is further disposed to the first connecting piece; two counterbores are disposed on the second connecting piece; a locating member passes the through hole; and a head of the locating member is inserted in either counterbore.

4. The connector for a foldable trampoline as claimed in claim 1, wherein a connecting pin is disposed between both through holes; and the connecting pin is inserted into two counterbores respectively provided in both through holes.

5. The connector for a foldable trampoline as claimed in claim 2, wherein one chamfer is disposed on the bottom of each of both working surfaces.

6. The connector for a foldable trampoline as claimed in claim 1, wherein the through hole is internally threaded.

7. The connector for a foldable trampoline as claimed in claim 3, wherein the through hole is internally threaded.
